(19) United States
(12) Patent Application Publication
(10) Pub. No.: US 2006/0293187 A1
(43) Pub. Date: Dec. 28, 2006

(54) Herbicidal mixtures based on 3-phenyluracils

(75) Inventors: Cyrill Zagar, Mannheim (DE); Matthias Witschel, Bad Durkheim (DE); Andreas Landes, Romerberg-Heiligenstein (DE)

Correspondence Address: ROTHWELL, FIGG, ERNST & MANBECK, P.C., 1425 K STREET, N.W., SUITE 800, WASHINGTON, DC, 20005, US

(73) Assignee: BASF Aktiengesellschaft, Ludwigshafen (DE)

(21) Appl. No.: 10/548,815

(22) PCT Filed: Mar. 5, 2004
(86) PCT No.: PCT/EP04/02239

§ 371 Date: Sep. 13, 2005

Related U.S. Application Data
(60) Provisional application No. 60/453,959, filed on Mar. 13, 2003.

(51) Int. Cl. A01N 43/60; A01N 43/00

(52) U.S. Cl. 504/129; 504/136

(57) ABSTRACT

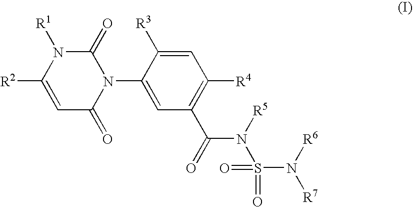

A herbicidal mixture comprising 3-Phenyluracils of the formula (I) in which the variables R¹-R⁷ are as defined below: R¹ is methyl or NH₂; R² is haloalkyl; R³ is hydrogen or halogen; R⁴ is halogen or cyano; R⁵ is hydrogen, cyano, alkyl, alkoxy, alkoxyalkyl, cyclo-alkyl, alkenyl, alkynyl or optionally substituted benzyl; R⁶, R⁷ are hydrogen, optionally substituted alkyl, alkoxy, alkenyl, alkynyl, cycloalkyl, cycloalkenyl, phenyl or benzyl; or R⁶, R⁷ together with the nitrogen atom form a 3- to 7-membered saturated or unsaturated optionally substituted hetero-cycle, including their agriculturally acceptable salts; and at least one further herbicide B; and optionally at least one safener C.

The present invention relates to herbicidally active compositions comprising 3-phenyluracils and at least one further herbicide and optionally at least one safener.

In crop protection products, it is desirable in principle to increase the specificity and the reliability of the action of active compounds. In particular, it is desirable for the crop protection product to control the harmful plants effectively and, at the same time, to be tolerated by the useful plants in question.

Various publications have described 3-phenyluracils as being highly effective herbicides. However, their compatibility with dicotyledonous crop plants such as cotton, oilseed rape and some graminaceous plants such as barley, millet, corn, rice, wheat and sugar cane is not always satisfactory, i.e. in addition to the harmful plants, the crop plants are also damaged to an extent which is not acceptable. It is possible to spare the useful plants by lowering the application rates; however the extent of the control of harmful plants is naturally also reduced.

It is known that certain combinations of different herbicides with specific action result in an enhanced activity of a herbicide component by synergism. As a consequence, it is possible to reduce the application rates of herbicidally active compounds required for controlling the harmful plants.

Furthermore, it is known that in some cases better crop plant compatibility can be achieved by joint application of specifically acting herbicides with organic active compounds, some of which are themselves herbicidally active. In these cases, the active compounds act as antidote or antagonist, and, owing to the fact that they can reduce or even prevent damage to the crop plants, they are also referred to as safeners.

3-Phenyluracils of the formula I: 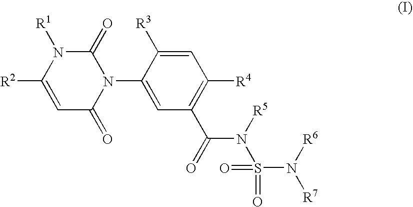
in which the variables R¹-R⁷ are as defined below:

R¹ is methyl or NH₂;

R² is C₁-C₂-haloalkyl;

R³ is hydrogen or halogen;

R⁴ is halogen or cyano;

R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;

R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the 8 abovementioned substituents is unsubstituted or substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl and benzyl; or

R⁶, R⁷ together with the nitrogen atom to which they are attached form a 3-, 4-, 5-, 6- or 7-membered saturated or unsaturated nitrogen heterocycle which may be substituted by 1 to 6 methyl groups and which may contain 1 or 2 further heteroatoms selected from the group consisting of nitrogen, oxygen and sulfur as ring members,

and their agriculturally acceptable salts are disclosed in the earlier patent application WO 01/83459. Certain herbicidal compositions of 3-phenyluracils of formula I are disclosed in the earlier patent application WO 03/24221.

It is an object of the present invention to increase the herbicidal activity of 3-phenyluracils of the formula I against undesirable harmful plants and to improve simultaneously their compatibility with useful plants.

We have found that this object is achieved, surprisingly, by compositions comprising at least one 3-phenyluracil of the formula I and

at least one further herbicide B, selected from the group consisting of

aminopyralid and its agriculturally acceptable derivates,

4-hydroxy-3-{[2-methyl-6-(trifluoromethyl)-3-pyridinyl]carbonyl}bicyclo[3.2.1]oct-3-en-2-one,

4-hydroxy-3-{[2-(2-methoxyethoxy)methyl-6-(trifluoromethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]-oct-3-en-2-one,

8-(2,6-diethyl-4-methylphenyl)-1,2,4,5-tetrahydro-9-hydroxy-7H-pyrazolo[1,2-d][1,4,5]oxadiazepin-7-one,

pivalic acid [8-(2,6-diethyl-4-methylphenyl)-1,2,4,5-tetrahydro-7-oxo-7H-pyrazolo[1,2-d][1,4,5]oxadiazepin-9-yl] ester (pinoxaden) and

[N-(5,7-dimethoxy[1,2,4]triazolo[1,5-a]pyrimidin-2-yl)-2-methoxy-4-(trifluoromethyl)-3-pyridinesulfonamide,

including their respective agriculturally acceptable salts;

and optionally

at least one safener C, selected from the group consisting of benoxacor, cloquintocet, cyometrinil, dichlormid, dicyclonon, dietholate, fenchlorazole, fenclorim, flurazole, fuxofenim, flurilazole, isoxadifen, mefenpyr, mephenate, naphthalic anhydride, 2,2,5-trimethyl-3-(dichloracetyl-1,3-oxazolidine (R-29148), 4-(dichloroacetyl)-1-oxa-4-azaspiro[4.5]decane (AD-67, MON 4660) and oxabetrinil,

including their agriculturally acceptable salts and, provided they have a carboxyl group, of their agriculturally acceptable derivatives.

The invention relates in particular to compositions in the form of herbicidally active crop protection compositions comprising a herbicidally effective amount of at least one mixture of I with B and optionally C, as defined above, and at least one liquid and/or solid carrier and, if desired, one or more surfactants and, if desired, one or more further auxiliaries customary for crop protection compositions. The invention also relates to compositions in the form of a crop protection composition formulated as a 2-component composition comprising a first component which comprises the active compound A, a solid or liquid carrier and, if appropriate, one or more surfactants, and a second component which comprises at least one further herbicide B and optionally a safener C, a solid or liquid carrier and, if appropriate, one or more surfactants, where both components may additionally comprise further auxiliaries customary for crop protection compositions.

The invention furthermore relates to a method for controlling undesirable vegetation, in particular in crops of cereals, corn, soybeans, rice, oilseed rape, cotton, potatoes, groundnuts or in perennial crops, and also in crops which, by genetic engineering or by breeding, are resistant to one or more herbicides or to attack by insects. The invention also relates to a method for the desiccation or defoliation of plants. In the latter methods it is immaterial whether the herbicidally active compounds of components A) and B) and optionally C) are formulated and applied jointly or separately, and, in the case of separate application, in which order the application takes place.

The organic moieties mentioned in the definition of the substituents R², R⁵, R⁶, R⁷ in formula I or as radicals on cycloalkyl, phenyl or heterocyclic rings are—like the term halogen—collective terms for individual enumerations of the individual group members. All hydrocarbon chains, i.e. all alkyl, haloalkyl, cycloalkyl, alkoxy, haloalkoxy, alkylamino, alkylthio, haloalkylthio, alkylsulfinyl, haloalkylsulfinyl, alkylsulfonyl, haloalkylsulfonyl, alkenyl and alkynyl groups and corresponding moieties in larger groups such as alkylcarbonyl, alkylaminocarbonyl, dialkylaminocarbonyl, alkoxycarbonyl, etc., can be straight-chain or branched, the prefix Cₙ-Cₘ denoting in each case the possible number of carbon atoms in the group. Halogenated substituents preferably carry one, two, three, four or five identical or different halogen atoms. The term halogen denotes in each case fluorine, chlorine, bromine or iodine.

Examples of other meanings are:
C₁-C₄-alkyl: CH₃, C₂H₅, n-propyl, CH(CH₃)₂, n-butyl, CH(CH₃)—C₂H₅, CH₂—CH(CH₃)₂ and C(CH₃)₃;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₄-alkoxy: OCH₃, OC₂H₅, n-propoxy, OCH(CH₃)₂, n-butoxy, OCH(CH₃)—C₂H₅, OCH₂—CH(CH₃)₂ or OC(CH₃)₃, preferably OCH₃, OC₂H₅ or OCH(CH₃)₂;
C₁-C₄-haloalkoxy: a C₁-C₄-alkoxy radical as mentioned above which is partially or fully substituted by fluorine, chlorine, bromine and/or iodine, i.e., for example, OCH₂F, OCHF₂, OCF₃, OCH₂Cl, OCH(Cl)₂, OC(Cl)₃, chlorofluoromethoxy, dichlorofluoromethoxy, chlorodifluoromethoxy, 2-fluoroethoxy, 2-chloroethoxy, 2-bromoethoxy, 2-iodoethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, OC₂F₅, 2-fluoropropoxy, 3-fluoropropoxy, 2,2-difluoropropoxy, 2,3-difluoropropoxy, 2-chloropropoxy, 3-chloropropoxy, 2,3-dichloropropoxy, 2-bromopropoxy, 3-bromopropoxy, 3,3,3-trifluoropropoxy, 3,3,3-trichloropropoxy, 2,2,3,3,3-pentafluoropropoxy, OCF₂—C₂F₅, 1-(CH₂F)-2-fluoroethoxy, 1-(CH₂Cl)-2-chloroethoxy, 1-(CH₂Br)-2-bromoethoxy, 4-fluorobutoxy, 4-chlorobutoxy, 4-bromobutoxy or nonafluorobutoxy, preferably OCHF₂, OCF₃, dichlorofluoromethoxy, chlorodifluoromethoxy or 2,2,2-trifluoroethoxy;
C₁-C₄-alkylthio: SCH₃, SC₂H₅, n-propylthio, SCH(CH₃)2, n-butylthio, SCH(CH₃)—C₂H₅, SCH₂—CH(CH₃)₂ or SC(CH₃)₃, preferably SCH₃ or SC₂H₅;
C₁-C₄-haloalkylthio: a C₁-C₄-alkylthio radical as mentioned above which is partially or fully substituted by fluorine, chlorine, bromine and/or iodine, i.e., for example, SCH₂F, SCHF₂, SCH₂Cl, SCH(Cl)₂, SC(Cl)₃, SCF₃, chlorofluoromethylthio, dichlorofluoromethylthio, chlorodifluoromethylthio, 2-fluoroethylthio, 2-chloroethylthio, 2-bromoethylthio, 2-iodoethylthio, 2,2-difluoroethylthio, 2,2,2-trifluoroethylthio, 2-chloro-2-fluoroethylthio, 2-chloro-2,2-difluoroethylthio, 2,2-dichloro-2-fluoroethylthio, 2,2,2-trichloroethylthio, SC₂F₅, 2-fluoropropylthio, 3-fluoropropylthio, 2,2-difluoropropylthio, 2,3-difluoropropylthio, 2-chloropropylthio, 3-chloropropylthio, 2,3-dichloropropylthio, 2-bromopropylthio, 3-bromopropylthio, 3,3,3-trifluoropropylthio, 3,3,3-trichloropropylthio, SCH₂—C₂F₅, SCF₂—C₂F₅, 1-(CH₂F)-2-fluoroethylthio, 1-(CH₂Cl)-2-chloroethylthio, 1-(CH₂Br)-2-bromoethylthio, 4-fluorobutylthio, 4-chlorobutylthio, 4-bromobutylthio or SCF₂—CF₂—C₂F₅, preferably SCHF₂, SCF₃, dichlorofluoromethylthio, chlorodifluoromethylthio or 2,2,2-trifluoroethylthio;
C₁-C₄-alkoxy-C₁-C₄-alkyl: C₁-C₄-alkyl which is substituted by C₁-C₄-alkoxy—as mentioned above—, i.e., for example, CH₂—OCH₃, CH₂—OC₂H₅, n-propoxymethyl, CH₂—OCH(CH₃)₂, n-butoxymethyl, (1-methylpropoxy)methyl, (2-methylpropoxy)methyl, CH₂—OC(CH₃)₃, 2-(methoxy)ethyl, 2-(ethoxy)ethyl, 2-(n-propoxy)ethyl, 2- (1-methylethoxy) ethyl, 2-(n-butoxy) ethyl, 2-(1-methylpropoxy)ethyl, 2-(2-methylpropoxy)ethyl, 2-(1,1-dimethylethoxy)ethyl, 2-(methoxy)propyl, 2-(ethoxy)propyl, 2-(n-propoxy)propyl, 2-(1-methylethoxy)propyl, 2-(n-butoxy)propyl, 2-(1-methylpropoxy)propyl, 2-(2-methylpropoxy)propyl, 2-(1,1-dimethylethoxy)propyl, 3-(methoxy)propyl, 3-(ethoxy)propyl, 3-(n-propoxy)propyl, 3-(1-methylethoxy)propyl, 3-(n-butoxy)propyl, 3-(1-methylpropoxy)propyl, 3-(2-methylpropoxy)propyl, 3-(1,1-dimethylethoxy)propyl, 2-(methoxy)butyl, 2-(ethoxy)butyl, 2-(n-propoxy)butyl, 2-(1-methylethoxy)butyl, 2-(n-butoxy)butyl, 2-(1-methylpropoxy)butyl, 2-(2-methylpropoxy)butyl, 2-(1,1-dimethylethoxy)butyl, 3-(methoxy)butyl, 3-(ethoxy)butyl, 3-(n-propoxy)butyl, 3-(1-methylethoxy)butyl, 3-(n-butoxy)butyl, 3-(1-methylpropoxy)butyl, 3-(2-methylpropoxy)butyl, 3-(1,1-dimethylethoxy)butyl, 4-(methoxy)butyl, 4-(ethoxy)butyl, 4-(n-propoxy)butyl, 4-(1-methylethoxy)butyl, 4-(n-butoxy)butyl, 4-(1-methylpropoxy)butyl, 4-(2-methylpropoxy)butyl or 4-(1,1-dimethylethoxy)butyl, preferably CH₂—OCH₃, CH₂—OC₂H₅, 2-methoxyethyl or 2-ethoxyethyl;
(C₁-C₄-alkyl)carbonyl: CO—CH₃, CO—C₂H₅, CO—CH₂—C₂H₅, CO—CH(CH₃)₂, n-butylcarbonyl, CO—CH(CH₃)—C₂H₅, CO—CH₂—CH(CH₃)₂ or CO—C(CH₃)₃, preferably CO—CH₃ or CO—C₂H₅;
(C₁-C₄-alkoxy)carbonyl: CO—OCH₃, CO—OC₂H₅, n-propoxycarbonyl, CO—OCH(CH₃)₂, n-butoxycarbonyl, CO—OCH(CH₃)—C₂H₅, CO—OCH₂—CH(CH₃)₂ or CO—OC(CH₃)₃, preferably CO—OCH₃ or CO—OC₂H₅;
C₁-C₄-alkylsulfonyl: SO₂—CH₃, SO₂—C₂H₅, SO₂—CH₂—C₂H₅, SO₂—CH(CH₃)₂, n-butylsulfonyl, SO₂—CH(CH₃)—C₂H₅, SO₂—CH₂—CH(CH₃)₂ or SO₂—C(CH₃)₃, preferably SO₂—CH₃ or SO₂—C₂H₅;
C₁-C₄-haloalkylsulfonyl: a C₁-C₄-alkylsulfonyl radical—as mentioned above—which is partially or fully substituted by fluorine, chlorine, bromine and/or iodine, i.e., for example, SO₂—CH₂F, SO₂—CHF₂, SO₂—CF₃, SO₂—CH₂Cl, SO₂—CH(Cl)₂, SO₂—C(Cl)₃, chlorofluoromethylsulfonyl, dichlorofluoromethylsulfonyl, chlorodifluoromethylsulfonyl, 2-fluoroethylsulfonyl, 2-chloroethylsulfonyl, 2-bromoethylsulfonyl, 2-iodoethylsulfonyl, 2,2-difluoroethylsulfonyl, 2,2,2-trifluoroethylsulfonyl, 2-chloro-2-fluoroethylsulfonyl, 2-chloro-2,2-difluoroethylsulfonyl, 2,2-dichloro-2-fluoroethylsulfonyl, 2,2,2-trichloroethylsulfonyl, SO₂—C₂F₅, 2-fluoropropylsulfonyl, 3-fluoropropylsulfonyl, 2,2-difluoropropylsulfonyl, 2,3-difluoropropylsulfonyl, 2-chloropropylsulfonyl, 3-chloropropylsulfonyl, 2,3-dichloropropylsulfonyl, 2-bromopropylsulfonyl, 3-bromopropylsulfonyl, 3,3,3-trifluoropropylsulfonyl, 3,3,3-trichloropropylsulfonyl, SO₂—CH₂—C₂F₅, SO₂—CF₂—C₂F₅, 1-(fluoromethyl)-2-fluoroethylsulfonyl, 1-(chloromethyl)-2-chloroethylsulfonyl, 1-(bromomethyl)-2-bromoethylsulfonyl, 4-fluorobutylsulfonyl, 4-chlorobutylsulfonyl, 4-bromobutylsulfonyl or nonafluorobutylsulfonyl, preferably SO₂—CF₃, SO₂—CH₂Cl or 2,2,2-trifluoroethylsulfonyl;
C₁-C₄-alkylamino: NH(CH₃), NH(C₂H₅), propylamino, NH[CH(CH₃)₂], butylamino, 1-methylpropylamino, 2-methylpropylamino, NH[C(CH₃)₃];
di(C₁-C₄-alkyl)amino: N(CH₃)₂, N(C₂H₅)₂, N,N-dipropylamino, N[CH(CH₃)₂]₂, N,N-dibutylamino, N,N-di(1-methylpropyl)amino, N,N-di(2-methylpropyl)amino, N[C(CH₃)₃]₂, N-ethyl-N-methylamino, N-methyl-N-propylamino, N-methyl-N-(1-methylethyl)amino, N-butyl-N-methylamino, N-methyl-N-(1-methylpropyl)amino, N-methyl-N-(2-methylpropyl)amino, N-(1,1-dimethylethyl)-N-methylamino, N-ethyl-N-propylamino, N-ethyl-N-(1-methylethyl)amino, N-butyl-N-ethylamino, N-ethyl-N-(1-methylpropyl)amino, N-ethyl-N-(2-methylpropyl)amino, N-ethyl-N-(1,1-dimethylethyl)amino, N-(1-methylethyl)-N-propylamino, N-butyl-N-propylamino, N-(1-methylpropyl)-N-propylamino, N-(2-methylpropyl)-N-propylamino, N-(1,1-dimethylethyl)-N-propylamino, N-butyl-N-(1-methylethyl)amino, N-(1-methylethyl)-N-(1-methylpropyl)amino, N-(1-methylethyl)-N-(2-methylpropyl)amino, N-(1,1-dimethylethyl)-N-(1-methylethyl)amino, N-butyl-N-(1-methylpropyl)amino, N-butyl-N-(2-methylpropyl)amino, N-butyl-N-(1,1-dimethylethyl)amino, N-(1-methylpropyl)-N-(2-methylpropyl)amino, N-(1,1-dimethylethyl)-N-(1-methylpropyl)amino or N-(1,1-dimethylethyl)-N-(2-methylpropyl)amino, preferably N(CH₃)₂ or N(C₂H₅);
C₁-C₄-alkylaminocarbonyl: for example methylaminocarbonyl, ethylaminocarbonyl, 1-methylethylaminocarbonyl, propylaminocarbonyl, butylaminocarbonyl, 1-methylpropylaminocarbonyl, 2-methylpropylaminocarbonyl, 1,1-dimethylethylaminocarbonyl;
di(C₁-C₄-alkyl)aminocarbonyl: for example N,N-dimethylaminocarbonyl, N,N-diethylaminocarbonyl, N,N-di(1-methylethyl)aminocarbonyl, N,N-dipropylaminocarbonyl, N,N-dibutylaminocarbonyl, N,N-di(1-methylpropyl)aminocarbonyl, N,N-di(2-methylpropyl)aminocarbonyl, N,N-di(1,1-dimethylethyl)aminocarbonyl, N-ethyl-N-methylaminocarbonyl, N-methyl-N-propylaminocarbonyl, N-methyl-N-(1-methylethyl)aminocarbonyl, N-butyl-N-methylaminocarbonyl, N-methyl-N-(1-methylpropyl)aminocarbonyl, N-methyl-N-(2-methylpropyl)aminocarbonyl, N-(1,1-dimethylethyl)-N-methylaminocarbonyl, N-ethyl-N-propylaminocarbonyl, N-ethyl-N-(1-methylethyl)aminocarbonyl, N-butyl-N-ethylaminocarbonyl, N-ethyl-N-(1-methylpropyl)aminocarbonyl, N-ethyl-N-(2-methylpropyl)aminocarbonyl, N-ethyl-N-(1,1-dimethylethyl)aminocarbonyl, N-(1-methylethyl)-N-propylaminocarbonyl, N-butyl-N-propylaminocarbonyl, N-(1-methylpropyl)-N-propylaminocarbonyl, N-(2-methylpropyl)-N-propylaminocarbonyl, N-(1,1-dimethylethyl)-N-propylaminocarbonyl, N-butyl-N-(1-methylethyl)aminocarbonyl, N-(1-methylethyl)-N-(1-methylpropyl)aminocarbonyl, N-(1-methylethyl)-N-(2-methylpropyl)aminocarbonyl, N-(1,1-dimethylethyl)-N-(1-methylethyl)aminocarbonyl, N-butyl-N-(1-methylpropyl)aminocarbonyl, N-butyl-N-(2-methylpropyl)aminocarbonyl, N-butyl-N-(1,1-dimethylethyl)aminocarbonyl, N-(1-methylpropyl)-N-(2-methylpropyl)aminocarbonyl, N-(1,1-dimethylethyl)-N-(1-methylpropyl)aminocarbonyl or N-(1,1-dimethylethyl)-N-(2-methylpropyl)aminocarbonyl;
C₃-C₆-alkenyl: prop-1-en-1-yl, allyl, 1-methylethenyl, 1-buten-1-yl, 1-buten-2-yl, 1-buten-3-yl, 2-buten-1-yl, 1-methylprop-1-en-1-yl, 2-methylprop-1-en-1-yl, 1-methylprop-2-en-1-yl, 2-methylprop-2-en-1-yl, n-penten-1-yl, n-penten-2-yl, n-penten-3-yl, n-penten-4-yl, 1-methylbut-1-en-1-yl, 2-methylbut-1-en-1-yl, 3-methylbut-1-en-1-yl, 1-methylbut-2-en-1-yl, 2-methylbut-2-en-1-yl, 3-methylbut-2-en-1-yl, 1-methylbut-3-en-1-yl, 2-methylbut-3-en-1-yl, 3-methylbut-3-en-1-yl, 1,1-dimethylprop-2-en-1-yl, 1,2-dimethylprop-1-en-1-yl, 1,2-dimethylprop-2-en-1-yl, 1-ethylprop-1-en-2-yl, 1-ethylprop-2-en-1-yl, n-hex-1-en-1-yl, n-hex-2-en-1-yl, n-hex-3-en-1-yl, n-hex-4-en-1-yl, n-hex-5-en-1-yl, 1-methylpent-1-en-1-yl, 2-methylpent-1-en-1-yl, 3-methylpent-1-en-1-yl, 4-methylpent-1-en-1-yl, 1-methylpent-2-en-1-yl, 2-methylpent-2-en-1-yl, 3-methylpent-2-en-1-yl, 4-methylpent-2-en-1-yl, 1-methylpent-3-en-1-yl, 2-methylpent-3-en-1-yl, 3-methylpent-3-en-1-yl, 4-methylpent-3-en-1-yl, 1-methylpent-4-en-1-yl, 2-methylpent-4-en-1-yl, 3-methylpent-4-en-1-yl, 4-methylpent-4-en-1-yl, 1,1-dimethylbut-2-en-1-yl, 1,1-dimethylbut-3-en-1-yl, 1,2-dimethylbut-1-en-1-yl, 1,2-dimethylbut-2-en-1-yl, 1,2-dimethylbut-3-en-1-yl, 1,3-dimethylbut-1-en-1-yl, 1,3-dimethylbut-2-en-1-yl, 1,3-dimethylbut-3-en-1-yl, 2,2-dimethylbut-3-en-1-yl, 2,3-dimethylbut-1-en-1-yl, 2,3-dimethylbut-2-en-1-yl, 2,3-dimethylbut-3-en-1-yl, 3,3-dimethylbut-1-en-1-yl, 3,3-dimethylbut-2-en-1-yl, 1-ethylbut-1-en-1-yl, 1-ethylbut-2-en-1-yl, 1-ethylbut-3-en-1-yl, 2-ethylbut-1-en-1-yl, 2-ethylbut-2-en-1-yl, 2-ethylbut-3-en-1-yl, 1,1,2-trimethylprop-2-en-1-yl, 1-ethyl-1-methylprop-2-en-1-yl, 1-ethyl-2-methylprop-1-en-1-yl or 1-ethyl-2-methylprop-2-en-1-yl;
C₃-C₆-alkynyl: prop-1-yn-1-yl, prop-2-yn-1-yl, n-but-1-yn-1-yl, n-but-1-yn-3-yl, n-but-1-yn-4-yl, n-but-2-yn-1-yl, n-pent-1-yn-1-yl, n-pent-1-yn-3-yl, n-pent-1-yn-4-yl, n-pent-1-yn-5-yl, n-pent-2-yn-1-yl, n-pent-2-yn-4-yl, n-pent-2-yn-5-yl, 3-methylbut-1-yn-3-yl, 3-methylbut-1-yn-4-yl, n-hex-1-yn-1-yl, n-hex-1-yn-3-yl, n-hex-1-yn-4-yl, n-hex-1-yn-5-yl, n-hex-. 1-yn-6-yl, n-hex-2-yn-1-yl, n-hex-2-yn-4-yl, n-hex-2-yn-5-yl, n-hex-2-yn-6-yl, n-hex-3-yn-1-yl, n-hex-3-yn-2-yl, 3-methylpent-1-yn-1-yl, 3-methylpent-1-yn-3-yl, 3-methylpent-1-yn-4-yl, 3-methylpent-1-yn-5-yl, 4-methylpent-1-yn-1-yl, 4-methylpent-2-yn-4-yl or 4-methylpent-2-yn-5-yl, preferably prop-2-yn-1-yl;
C₃-C₇-cycloalkyl: cyclopropyl, cyclobutyl, cyclopentyl, cyclohexyl or cycloheptyl;

The active compound aminopyralid and the active compounds C are known herbicides and safeners, see, for example

The Compendium of Pesticide Common Names (http://www.hclrss.demon.co.uk/index.html);

Farm Chemicals Handbook 2000 Vol. 86, Meister Publishing Company, 2000;

B. Hock, C. Fedtke, R. R. Schmidt, Herbizide, Georg Thieme Verlag, Stuttgart 1995;

W. H. Ahrens, Herbicide Handbook, 7^{th} Edition, Weed Science Society of America, 1994; and

K. K. Hatzios, Herbicide Handbook, Supplement to 7^{th} Edition, Weed Science Society of America, 1998.

2,2,5-Trimethyl-3-(dichloroacetyl)-1,3-oxazolidine (CAS No. 52836-31-4) is also known under the name R-29148.

4-(Dichloroacetyl)-1-oxa-4- azaspiro[4.5]decane (CAS No. 71526-07-03) is also known under the names AD-67 and MON 4660.

4-Hydroxy-3-([2-methyl-6-(trifluoromethyl)-3-pyridinyl]carbonyl) bicyclo[3.2.1]oct-3-en-2-one (CAS 261634-96-2) is known from WO 2000/15615. 4-Hydroxy-3-[[2-[(2-methoxyethoxy)methyl]-6-(trifluoromethyl)-3-pyridinyl]carbonyl]bicyclo[3.2.1]oct-3-en-2-one (CAS 352010-68-5) is known from WO 2001/94339.

4-Hydroxy-3-[4-methylsulfonyl)-2-nitrobenzoyl]bicyclo[3.2.1]oct-3-en-2-one (CAS 137014-61-0) is known from WO 2000/00029.

8-(2,6-Diethyl-4-methylphenyl)-1,2,4,5-tetrahydro-9-hydroxy-7H-pyrazolo[1,2-d][1,4,5]oxadiazepin-7-one (CAS 243973-19-5) and pivalic acid [8-(2,6-diethyl-4-methylphenyl)-1,2,4,5-tetrahydro-7-oxo-7H-pyrazolo[1,2-d][1,4,5]oxadiazepin-9-yl]ester (CAS 243973-20-8) are known from WO 1999/47525 and WO 2000/47585.

Privalic acid [8-(2,6-diethyl-4-methylphenyl)-1,2,4,5-tetrahydro-7-oxo-7H-pyrazolo[1,2-d](1,4,5]oxadiazepin-9-yl] ester is also known under the name pinoxaden.

[N-5,7-Dimethoxy[1,2,4]triazolo[1,5-a]pyrimidin-2-yl)-2-methoxy-4-(trifluoromethyl)-3-pyridinesulfonamide (CAS 422556-08-9) is known from WO 2002/36595.

If the phenyluracils I, the herbicides B and/or the safeners C are capable of forming geometrical isomers, for example E/Z isomers, it is possible to use both the pure isomers and mixtures thereof in the compositions according to the invention. If the phenyluracils I, the herbicides B and/or the safeners C have one or more centers of chirality and, as a consequence, are present as enantiomers or diastereomers, it is possible to use both the pure enantiomers and diastereomers and their mixtures in the compositions according to the invention.

If the phenyluracils I, the herbicides B and/or the safeners C have functional groups which can be ionized, they can also be used in the form of their agriculturally acceptable salts. In general, the salts of those cations are suitable whose cations have no adverse effect on the action of the active compounds (“agricultural acceptable”).

Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

It is possible to use, for example, the active compounds of formula I and aminopyralid,

4-hydroxy-3-{[2-methyl-6-(trifluoromethyl-3-pyridinyl]carbonyl}bicyclo[3.2.1]oct-3-en-2-one,

4-hydroxy-3-{[2-(2-methoxyethoxy)methyl-6-(trifluoromethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]oct-3-en-2-one,

8-(2,6-diethyl-4-methylpenyl)-1,2,4,5-tetrahydro-9-hydroxy-7H-pyrazolo[1,2-d][1,4,5]oxadiazepin-7-one,

[N-(5,7-dimethoxy[1,2,4]triazolo[1,5-a)]pyrimidin-2-yl)-2-methoxy-4-(trifluoromethyl)-3-pyridinesulfonamide, cloquintocet, fenchlorazole, isoxadifen and mefenpyr, if desired, as salts of the agriculturally useful cations mentioned above, in the compositions according to the invention.

In the compositions according to the invention, the active compounds B and/or C which carry a carboxyl group can, instead of the active compounds mentioned above, also be employed in the form of an agriculturally acceptable derivative, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Examples of active compounds having a COOH group which can also be employed as derivatives are: aminopyralid, cloquintocet, fenchlorazole, isoxadifen ad mefenpyr.

Preferred mono- and di-C₁-C₆-alkylamides are the methyl- and the dimethylamides.

Preferred arylamides are, for example, the anilidines and the 2-chloroanilides.

Preferred alkyl esters are, for example, the methyl, ethyl, propyl, isopropyl, butyl, isobutyl, pentyl, mexyl (1-methylhexyl) or isooctyl (2-ethylhexyl) esters.

Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester.

Among the 3-phenyluracils of the formula I, preference is given to those in which the variables R¹ to R⁷ have the meanings given below:

R¹ is methyl or NH₂;

R² is trifluoromethyl;

R³ is hydrogen, fluorine or chlorine, in particular fluorine;

R⁴ is halogen or cyano, in particular chlorine or cyano;

R⁵ is hydrogen;

R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl or

R⁶, R⁷ together with the nitrogen atom to which they are attached form a pyrrolidine, piperidine, morpholine, N-methylpiperazine or perhydroazepine ring.

R⁶, R⁷ are in particular identical or different C₁-C₆-alkyl radicals.

In a particularly preferred embodiment of the invention, the compositions comprise at least one 3-phenyluracil I in which the variables R¹ to R⁷ in formula I have the following meanings (hereinbelow also referred to as phenyluracils Ia):

R¹ is methyl;

R² is trifluoromethyl;

R³ is fluorine;

R⁴ is chlorine;

R⁵ is hydrogen;

R⁶, R⁷ independently of one another are C₁-C₆-alkyl.

In another particularly preferred embodiment of the invention, the compositions comprise at least one 3-phenyluracil I in which the variables R¹ to R⁷ in formula I have the meanings below (hereinbelow also referred to as phenyluracils Ib):

R¹ is NH₂;

R² is trifluoromethyl;

R³ is fluorine;

R⁴ is chlorine;

R⁵ is hydrogen;

R⁶, R⁷ independently of one another are C₁-C₆-alkyl.

Examples of particularly preferred herbicides Ia or Ib are the compounds of the formula I′ listed below in which R¹, R⁶ and R⁷ together have the meanings given in one row of table 1 (compounds I.1 to I.74).

TABLE 1

| | |
|---|---|
| | (I′) |
| 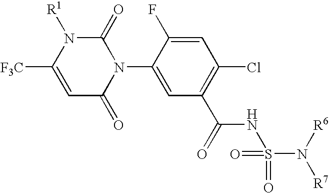 | |

| Phenyluracil I | R¹ | R⁶ | R⁷ |
|---|---|---|---|
| I.1 | methyl | methyl | methyl |
| I.2 | amino | methyl | methyl |
| I.3 | methyl | methyl | ethyl |
| I.4 | amino | methyl | ethyl |
| I.5 | methyl | methyl | propyl |
| I.6 | amino | methyl | propyl |
| I.7 | methyl | methyl | isopropyl |
| I.8 | amino | methyl | isopropyl |
| I.9 | methyl | methyl | butyl |
| I.10 | amino | methyl | butyl |
| I.11 | methyl | methyl | s-butyl |
| I.12 | amino | methyl | s-butyl |
| I.13 | methyl | methyl | isobutyl |
| I.14 | amino | methyl | isobutyl |
| I.15 | methyl | methyl | t-butyl |
| I.16 | amino | methyl | t-butyl |
| I.17 | methyl | methyl | n-pentyl |
| I.18 | amino | methyl | n-pentyl |
| I.19 | methyl | methyl | n-hexyl |
| I.20 | amino | methyl | n-hexyl |
| I.21 | methyl | methyl | allyl |
| I.22 | amino | methyl | allyl |
| I.23 | methyl | methyl | propargyl |
| I.24 | amino | methyl | propargyl |
| I.25 | methyl | methyl | phenyl |
| I.26 | amino | methyl | phenyl |
| I.27 | methyl | methyl | benzyl |
| I.28 | amino | methyl | benzyl |
| I.29 | methyl | ethyl | ethyl |
| I.30 | amino | ethyl | ethyl |
| I.31 | methyl | ethyl | propyl |
| I.32 | amino | ethyl | propyl |
| I.33 | methyl | ethyl | isopropyl |
| I.34 | amino | ethyl | isopropyl |
| I.35 | methyl | ethyl | butyl |
| I.36 | amino | ethyl | butyl |
| I.37 | methyl | ethyl | n-pentyl |
| I.38 | amino | ethyl | n-pentyl |
| I.39 | methyl | ethyl | n-hexyl |
| I.40 | amino | ethyl | n-hexyl |
| I.41 | methyl | propyl | propyl |
| I.42 | amino | propyl | propyl |
| I.43 | methyl | propyl | isopropyl |
| I.44 | amino | propyl | isopropyl |
| I.45 | methyl | propyl | butyl |
| I.46 | amino | propyl | butyl |
| I.47 | methyl | propyl | n-pentyl |
| I.48 | amino | propyl | n-pentyl |
| I.49 | methyl | propyl | n-hexyl |
| I.50 | amino | propyl | n-hexyl |
| I.51 | methyl | isopropyl | isopropyl |
| I.52 | amino | isopropyl | isopropyl |
| I.53 | methyl | isopropyl | butyl |
| I.54 | amino | isopropyl | butyl |
| I.55 | methyl | isopropyl | n-pentyl |
| I.56 | amino | isopropyl | n-pentyl |
| I.57 | methyl | isopropyl | n-hexyl |
| I.58 | amino | isopropyl | n-hexyl |
| I.59 | methyl | butyl | butyl |
| I.60 | amino | butyl | butyl |
| I.61 | methyl | butyl | n-pentyl |
| I.62 | amino | butyl | n-pentyl |
| I.63 | methyl | butyl | n-hexyl |
| I.64 | amino | butyl | n-hexyl |
| I.65 | methyl | n-pentyl | n-pentyl |
| I.66 | amino | n-pentyl | n-pentyl |
| I.67 | methyl | n-pentyl | n-hexyl |
| I.68 | amino | n-pentyl | n-hexyl |
| I.69 | methyl | n-hexyl | n-hexyl |
| I.70 | amino | n-hexyl | n-hexyl |

| | | |
|---|---|---|
| I.71 | methyl | —(CH₂)₄— |
| I.72 | amino | —(CH₂)₄— |
| I.73 | methyl | —(CH₂)₂—O—(CH₂)₂— |
| I.74 | amino | —(CH₂)₂—O—(CH₂)₂— |

Preferred herbicides B which can be used according to the present invention in combination with the 3-phenyluracils of formula I are selected from the group consisting of aminopyralid and its agriculturally acceptable derivatives,

4-hydroxy-3-{[2-methyl-6-(trifluoromethyl)-3-pyridinyl]carbonyl} bicyclo[3.2.1]oct-3-en-2-one,

4-hydroxy-3-{[2-(2-methoxyethoxy)methyl-6-(trifluormethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]oct-3-en-2-one,

8-(2,6-diethyl-4-methylphenyl)-1,2,4,5-tetrahydro-9-hydroxy-7H-pyrazolo[1,2-d)(1,4,5]oxadiazepin-7-one and

pivalic acid [8-(2,6-diethyl-4-methylphenyl)-1,2,4,5-tetrahydro-7-oxo-7H-pyrazolo[1,2-d][1,4,5]oxadiazepin-9-yl]ester(pinoxaden),

including their respective agriculturally acceptable salts;

Also preferred herbicides B which can be used according to the present invention in combination with the 3-phenyluracils of the formula I are selected from the group consisting of aminopyralid and its agriculturally acceptable derivatives,

4-hydroxy-3-{[2-(2-methoxyethoxy)methyl-6-(trifluormethyl)-3-pyridinyl]carbonyl}bicyclo[3.2.1]oct-3-en-2-one, pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden) and

[N-(5,7-dimethoxy[1,2,4]triazolo[1,5-a]pyrimidin-2-yl)-2-methoxy-4-(trifluoromethyl)-3-pyridinesulfonamide, including their respective agricultural acceptable salts.

As active compounds C, the compositions according to the invention particularly preferably comprise at least one of the compounds listed below: benoxacor, cloquintocet, dichlormid, fenchlorazole, fenclorim, fluxofenim, furilazole, isoxadifen, mefenpyr, 2,2,5-trimethyl-3-(dichloracetyl)-1,3-oxazolidine, 4-(dichloroacetyl)-1-oxa-4-azaspiro[4.5]decane and oxabetrinil and/or an agriculturally acceptable salt thereof and/or, in the case of compounds having a COOH group, an agriculturally acceptable derivative.

Particular preference is given to those binary and ternary compositions which comprise at least one 3-phenyluracil of the formula I and at least one herbicide B and, if appropriate, one or more safeners C.

Here and below, the term “binary compositions” includes compositions which comprise one or more, for example 2 or 3, active compounds I and one or more, for example 2 or 3, herbicides B. Correspondingly, the term “ternary compositions” includes compositions which comprise one or more, for example 2 or 3, active compounds I, one or more, for example 2 or 3, herbicides B and one or more, for example 2 or 3, safeners C.

In binary compositions the weight ratio of the active compounds I:B is usually in the range from 1:500 to 10:1, preferably in the range from 1:100 to 10:1, in particular in the range from 1:50 to 10:1 and particularly preferably in the range from 1:25 to 5:1.

In ternary compositions which comprise both a 3-phenyluracil I, at least one herbicide B and at least one safener C, the relative weight ratios of the components I:B:C are usually in the range from 10:1:1 to 1:500:10, preferably from 10:1:1 to 1:100:10, in particular from 10:1:1 to 1:50:1 and particularly preferably from 5:1:1 to 1:25:5. In these ternary compositions, the weight ratio of herbicide B to safener C is preferably in the range from 50:1 to 1:10.

In a particular preferred embodiment of the invention, preference is given to those compositions of the invention which comprise a 3-phenyluracil of the formula I, especially of the formula Ia or Ib;

in combination with at least one, especially exacty one herbicide B selected from the group consisting of

aminopyralid and its agriculturally acceptable derivates,

4-hydroxy-3-{[2-methyl-6-(trifluoromethyl)-3-pyridinyl]carbonyl}bicyclo[3.2.1]oct-3-en-2-one,

4-hydroxy-3-{[2-(2-methoxyethoxy)methyl-6-(trifluoromethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]-oct-3-en-2-one,

8-(2,6-diethyl-4-methylphenyl)-1,2,4,5-tetrahydro-9-hydroxy-7H-pyrazolo[1,2-d][1,4,5]oxadiazepin-7-one and

pivalic acid [8-(2,6-diethyl-4-methylphenyl)-1,2,4,5-tetrahydro-7-oxo-7H-pyrazolo[1,2-d][1,4,5]oxadiazepin-9-yl] ester (pinoxaden),

including their respective agriculturally acceptable salts,

in particular aminopyralid,

4-hydroxy-3-{[2-methyl-6-(trifluoromethyl)-3-pyridinyl]carbonyl}bicyclo[3.2.1]oct-3-en-2-one,

4-hydroxy-3-{[2-(2-methoxyethoxy)methyl-6-(trifluoromethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]-oct-3-en-2-one,

8-(2,6-diethyl-4-methylphenyl)-1,2,4,5-tetrahydro-9-hydroxy-7H-pyrazolo[1,2-d][1,4,5]oxadiazepin-7-one and

pivalic acid [8-(2,6-diethyl-4-methylphenyl)-1,2,4,5-tetrahydro-7-oxo-7H-pyrazolo[1,2-d][1,4,5]oxadiazepin-9-yl] ester (pinoxaden); and, if desired,

a safener C, in particular selected from the group consisting fenclorazole, cloquintocet, isoxadifen and mefenpyr.

In another particular preferred embodiment of the invention, preference is given to those compositions of the invention which comprise a 3- phenyluracil of the formula I, especially of the formulae Ia or Ib;

in combination with aminopyralid; and, if desired,

a safener C, in particular selected from the group consisting of fenclorazole, cloquintocet, isoxadifen and mefenpyr.

In another particular preferred embodiment of the invention, preference is given to those compositions of the invention which comprise a 3-phenyluracil of the formula I, especially of formulae Ia or Ib;

in combination with at least one, especially exactly one herbicide B selected from the group consisting of

4-hydroxy-3-{[2-methyl-6-(trifluoromethyl)-3-pyridinyl]carbonyl} bicyclo[3.2.1]oct-3-en-2-one,

4-hydroxy-3-{[2-2-methoxyethoxy)methyl-6-(trifluoromethyl)-3-pyridinyl]carbonyl}bicyclo[3.2.1]oct-3-en-2-one,

4-hydroxy-3-[4-(methylsulfonyl)-2-nitrobenzoyl]bicyclo[3.2.1]oct-3-en-2-one,

in particular 4-hydroxy-3-{[2-(2-methoxyethoxy)methyl-6-(trifluoromethyl)-3-pyridinyl]carbonyl}bicyclo[3.2.1]oct-3-en-2-one;

and, if desired,

a safener C, in particular selected from the group consisting of fenclorazole, cloquintocet, isoxadifen and mefenpyr.

In another particular preferred embodiment of the invention, preference is given to those compositions of the invention which comprise a 3-phenyluracil of the formula I, specially of formulae Ia or Ib;

in combination with at least one, especially exactly one herbicide B selected from the group consisting of

8-(2,6-diethyl-4-methylphenyl)-1,2,4,5-tetrahydro-9-hydroxy-7H-pyrazolo[1,2-d][1,4,5]oxadiazepin-7-one,

pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden),

in particular pivalic acid [8-(2,6-diethyl-4-methylphenyl)-1,2,4,5-tetrahydro-7-oxo-7H-pyrazolo[1,2-d][1,4,5]oxadiazepin-9-yl] ester (pinoxaden); and, if desired,

a safener C, in particular selected from the group consisting of fenclorazole, cloquintocet, isoxadifen and mefenpyr.

In another particular preferred embodiment of the invention, preference is given to those compositions of the invention which comprise a 3-phenyluracil of the formula I, especially of formulae Ia or Ib;

in combination with [N-(5,7-dimethoxy[1,2,4]triazolo[1,5-a]pyrimidin-2-yl)-2-methoxy-4-(trifluromethyl)-3-pyridinesulfonamide; and, if desired,

a safener C, in particular selected from the group consisting of fenclorazole, cloquintocet, isoxadifen and mefenpyr.

In the preferred or especially preferred compositions described above the herbicides B as well as the safeners C can be used in the form of their agriculturally acceptable salts or in the form of an agriculturally acceptable derivative thereof as described above. The weight ratios of the individual components in the compositions are within the limits stated above. Among the especially preferred compositions, particular preference is given to those compositions of the invention in which the variables R¹ to R⁷ have the preferred meanings, especially the particularly preferred meanings. Particular preference is given to 3-phenyluracil of the formula Ia or Ib as defined above.

Preference is given, for example, to those compositions which, as active compound I, comprise the phenyluracil I.1 and, as further active compound, the substances listed in one row of table 2 (compositions 1.1 to 1.43). The weight ratios of the individual components in the compositions 1.1 to 1.43 are within the stated limits, in the case of binary mixtures of phenyluracil I.1 and herbicide B for example 1:1, in the case of binary mixtures of phenyluracil I.1 and safener C for example 1:1 and in the case of ternary mixtures of phenyluracil I.1, herbicide B and safener C for example 1:1:1, 2:1:1, 1:2:1, 1:5:1 or 1:5:2.

TABLE 2

| Composition | | |
|---|---|---|
| No. | Herbicide B | Safener C |
| 1.1 | aminopyralid | — |
| 1.2 | aminopyralid | benoxacor |
| 1.3 | aminopyralid | cloquintocet |
| 1.4 | aminopyralid | dichlormid |
| 1.5 | aminopyralid | fenchlorazole |
| 1.6 | aminopyralid | fenclorim |
| 1.7 | aminopyralid | fluxofenim |
| 1.8 | aminopyralid | furilazole |
| 1.9 | aminopyralid | isoxadifen |
| 1.10 | aminopyralid | mefenpyr |
| 1.11 | aminopyralid | 2,2,5-trimethyl- |
| | | 3-(dichloracetyl)-1,3- |
| | | oxazolidine |
| 1.12 | aminopyralid | 4-(dichloroacetyl)-1-oxa-4- |
| | | azaspiro |
| | | [4.5]decane |
| 1.13 | aminopyralid | oxabetrinil |
| 1.14 | 4-hydroxy-3-{[2-methyl-6-(trifluoromethyl)- | — |
| | 3-pyridinyl]carbonyl} | |
| | bicyclo[3.2.1]oct-3-en-2-one | |
| 1.15 | 4-hydroxy-3-{[2-methyl-6-(trifluoromethyl)- | cloquintocet |
| | 3-pyridinyl]carbonyl} | |
| | bicyclo[3.2.1]oct-3-en-2-one | |
| 1.16 | 4-hydroxy-3-{[2-methyl-6-(trifluoromethyl)- | fenchlorazole |
| | 3-pyridinyl]carbonyl}bicyclo | |
| | [3.2.1]oct-3-en-2-one | |
| 1.17 | 4-hydroxy-3-{[2-methyl-6-(trifluoromethyl)- | isoxadifen |
| | 3-pyridinyl]carbonyl}bicyclo | |
| | [3.2.1]oct-3-en-2-one | |
| 1.18 | 4-hydroxy-3-{[2-(2-methoxy- | mefenpyr |
| | ethoxy)methyl-6-(trifluoromethyl)- | |
| | 3-pyridinyl]carbonyl} | |
| | bicyclo[3.2.1]oct-3-en-2-one | |
| 1.19 | 4-hydroxy-3-{[2-(2-methoxy- | — |
| | ethoxy)methyl-6-(trifluoromethyl)- | |
| | 3-pyridinyl]carbonyl} | |
| | bicyclo[3.2.1]oct-3-en-2-one | |
| 1.20 | 4-hydroxy-3-{[2-(2-methoxy- | cloquintocet |
| | ethoxy)methyl-6-(trifluoromethyl)- | |
| | 3-pyridinyl]carbonyl} | |
| | bicyclo[3.2.1]oct-3-en-2-one | |
| 1.21 | 4-hydroxy-3-{[2-(2-methoxy- | fenchlorazole |
| | ethoxy)methyl-6-(trifluoromethyl)- | |
| | 3-pyridinyl]carbonyl} | |
| | bicyclo[3.2.1]oct-3-en-2-one | |
| 1.22 | 4-hydroxy-3-{[2-(2-methoxy- | isoxadifen |
| | ethoxy)methyl-6-(trifluoromethyl)- | |
| | 3-pyridinyl]carbonyl} | |
| | bicyclo[3.2.1]oct-3-en-2-one | |
| 1.23 | 4-hydroxy-3-{[2-(2-methoxy- | mefenpyr |
| | ethoxy)methyl-6-(trifluoromethyl)- | |
| | 3-pyridinyl]carbonyl} | |
| | bicyclo[3.2.1]oct-3-en-2-one | |
| 1.24 | 4-hydroxy-3-[4-(methylsulfonyl)-2- | — |
| | nitrobenzoyl]bicyclo[3.2.1] | |
| | oct-3-en-2-one | |
| 1.25 | 4-hydroxy-3-[4-(methylsulfonyl)-2- | cloquintocet |
| | nitrobenzoyl]bicyclo[3.2.1] | |
| | oct-3-en-2-one | |
| 1.26 | 4-hydroxy-3-[4-(methylsulfonyl)-2- | fenchlorazole |
| | nitrobenzoyl]bicyclo[3.2.1] | |
| | oct-3-en-2-one | |
| 1.27 | 4-hydroxy-3-[4-(methylsulfonyl)-2- | isoxadifen |
| | nitrobenzoyl]bicyclo[3.2.1] | |
| | oct-3-en-2-one | |
| 1.28 | 4-hydroxy-3-[4-(methylsulfonyl)-2- | mefenpyr |
| | nitrobenzoyl]bicyclo[3.2.1] | |
| | oct-3-en-2-one | |
| 1.29 | 8-(2,6-diethyl-4-methylphenyl)- | — |
| | 1,2,4,5-tetrahydro-9-hydroxy-7H-pyrazolo | |
| | [1,2-d][1,4,5]oxadiazepin- | |
| | 7-one | |
| 1.30 | 8-(2,6-diethyl-4-methylphenyl)- | cloquintocet |
| | 1,2,4,5-tetrahydro-9-hydroxy-7H-pyrazolo | |
| | [1,2-d][1,4,5]oxadiazepin- | |
| | 7-one | |
| 1.31 | 8-(2,6-diethyl-4-methylphenyl)- | fenchlorazole |
| | 1,2,4,5-tetrahydro-9-hydroxy-7H-pyrazolo | |
| | [1,2-d][1,4,5]oxadiazepin- | |
| | 7-one | |
| 1.32 | 8-(2,6-diethyl-4-methylphenyl)- | isoxadifen |
| | 1,2,4,5-tetrahydro-9-hydroxy-7H-pyrazolo | |
| | [1,2-d][1,4,5]oxadiazepin- | |
| | 7-one | |
| 1.33 | 8-(2,6-diethyl-4-methylphenyl)- | mefenpyr |
| | 1,2,4,5-tetrahydro-9-hydroxy-7H-pyrazolo | |
| | [1,2-d][1,4,5]oxadiazepin- | |
| | 7-one | |
| 1.34 | pinoxaden | — |
| 1.35 | pinoxaden | cloquintocet |
| 1.36 | pinoxaden | fenchlorazole |
| 1.37 | pinoxaden | isoxadifen |
| 1.38 | pinoxaden | mefenpyr |
| 1.39 | [N-(5,7-dimethoxy[1,2,4]triazolo | — |
| | [1,5-a]pyrimidin-2-yl)-2-methoxy-4- | |
| | (trifluoromethyl)-3-pyridine-sulfonamide | |
| 1.40 | [N-(5,7-dimethoxy[1,2,4]triazolo | cloquintocet |
| | [1,5-a]pyrimidin-2-yl)-2-methoxy-4- | |
| | (trifluoromethyl)-3-pyridine-sulfonamide | |
| 1.41 | [N-(5,7-dimethoxy[1,2,4]triazolo | fenchlorazole |
| | [1,5-a]pyrimidin-2-yl)-2-methoxy-4- | |
| | (trifluoromethyl)-3-pyridine-sulfonamide | |
| 1.42 | [N-(5,7-dimethoxy[1,2,4]triazolo | isoxadifen |
| | [1,5-a]pyrimidin-2-yl)-2-methoxy-4- | |
| | (trifluoromethyl)-3-pyridine-sulfonamide | |
| 1.43 | [N-(5,7-dimethoxy[1,2,4]triazolo | mefenpyr |
| | [1,5-a]pyrimidin-2-yl)-2-methoxy-4- | |
| | (trifluoromethyl)-3-pyridine-sulfonamide | |

If the active compounds mentioned in table 2 have functional groups which can be ionized, they can, of course, also be present in the form of their agriculturally acceptable salts. In the case of acidic active compounds, i.e. active compounds which can be deprotonated, these are in particular the lithium, sodium, potassium, calcium, magnesium, ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di-(2-hydroxyeth-1-yl)ammonium, benzyltrimethylammonium, benzyltriethylammonium or trimethylsulfonium salts. In the case of basic active compounds, i.e. active compounds which can be protonated, these are in particular the chlorides, bromides, sulfates, hydrogen sulfates, methylsulfates, dihydrogen phosphates or hydrogen phosphates of the active compounds mentioned above. If the active compounds mentioned in table 2 have a carboxyl group they can, of course, also be present in the form of agriculturally acceptable derivatives, in particular in the form of their methyl- and dimethylamides, in the form of their anilides or 2-chloroanilides, and also in the form of their methyl, ethyl, propyl, isopropyl, butyl, isobutyl, pentyl, hexyl, isooctyl, methoxyethyl, ethoxyethyl, butoxyethyl or thioethyl esters.

Preference is also given to the compositions 2.1-2.43 which differ from the corresponding compositions 1.1-1.43 only in that the phenyluracil I.1 is replaced by the phenyluracil I.2.

Preference is also given to the compositions 3.1-3.43 which differ from the corresponding compositions 1.1-1.43 only in that the phenyluracil I.1 is replaced by the phenyluracil I.3.

Preference is also given to the compositions 4.1-4.43 which differ from the corresponding compositions 1.1-1.43 only in that the phenyluracil I.1 is replaced by the phenyluracil I.4.

Preference is also given to the compositions 5.1-5.43 which differ from the corresponding compositions 1.1-1.43 only in that the phenyluracil I.1 is replaced by the phenyluracil I.5.

Preference is also given to the compositions 6.1-6.43 which differ from the corresponding compositions 1.1-1.43 only in that the phenyluracil I.1 is replaced by the phenyluracil I.6.

Preference is also given to the compositions 7.1-7.43 which differ from the corresponding compositions 1.1-1.43 only in that the phenyluracil I.1 is replaced by the phenyluracil I.7.

Preference is also given to the compositions 8.1-8.43 which differ from the corresponding compositions 1.1-1.43 only in that the phenyluracil I.1 is replaced by the phenyluracil I.8.

Preference is also given to the compositions 9.1-9.43 which differ from the corresponding compositions 1.1-1.43 only in that the phenyluracil I.1 is replaced by the phenyluracil I.9.

Preference is also given to the compositions 10.1-10.43 which differ from the corresponding compositions 1.1-1.43 only in that the phenyluracil I.1 is replaced by the phenyluracil I.10.

Preference is also given to the compositions 11.1-11.43 which differ from the corresponding compositions 1.1-1.43 only in that the phenyluracil I.1 is replaced by the phenyluracil I.11.

Preference is also given to the compositions 12.1-12.43 which differ from the corresponding compositions 1.1-1.43 only in that the phenyluracil I.1 is replaced by the phenyluracil 1.12.

Preference is also given to the compositions 13.1-13.43 which differ from the corresponding compositions 1.1-1.43 only in that the phenyluracil I.1 is replaced by the phenyluracil I.13.

Preference is also given to the compositions 14.1-14.43 which differ from the corresponding compositions 1.1-1.43 only in that the phenyluracil I.1 is replaced by the phenyluracil I.14.

Preference is also given to the compositions 15.1-15.43 which differ from the corresponding compositions 1.1-1.43 only in that the phenyluracil I.1 is replaced by the phenyluracil I.15.

Preference is also given to the compositions 16.1-16.43 which differ from the corresponding compositions 1.1-1.43 only in that the phenyluracil I.1 is replaced by the phenyluracil I.16.

Preference is also given to the compositions 17.1-17.43 which differ from the corresponding compositions 1.1-1.43 only in that the phenyluracil 1.1 is replaced by the phenyluracil I.17.

Preference is also given to the compositions 18.1-18.43 which differ from the corresponding compositions 1.1-1.43 only in that the phenyluracil I.1 is replaced by the phenyluracil I.18.

Preference is also given to the compositions 19.1-19.43 which differ from the corresponding compositions 1.1-1.43 only in that the phenyluracil 1.1 is replaced by the phenyluracil 1.19.

Preference is also given to the compositions 20.1-20.43 which differ from the corresponding compositions 1.1-1.43 only in that the phenyluracil I.1 is replaced by the phenyluracil I.20.

Preference is also given to the compositions 21.1-21.43 which differ from the corresponding compositions 1.1-1.43 only in that the phenyluracil I.1 is replaced by the phenyluracil I.21.

Preference is also given to the compositions 22.1-22.43 which differ from the corresponding compositions 1.1-1.43 only in that the phenyluracil I.1 is replaced by the phenyluracil I.22.

Preference is also given to the compositions 23.1-23.43 which differ from the corresponding compositions 1.1-1.43 only in that the phenyluracil I.1 is replaced by the phenyluracil I.23.

Preference is also given to the compositions 24.1-24.43 which differ from the corresponding compositions 1.1-1.43 only in that the phenyluracil I.1 is replaced by the phenyluracil I.24.

Preference is also given to the compositions 25.1-25.43 which differ from the corresponding compositions 1.1-1.43 only in that the phenyluracil I.1 is replaced by the phenyluracil I.25.

Preference is also given to the compositions 26.1-26.43 which differ from the corresponding compositions 1.1-1.43 only in that the phenyluracil I.1 is replaced by the phenyluracil I.26.

Preference is also given to the compositions 27.1-27.43 which differ from the corresponding compositions 1.1-1.43 only in that the phenyluracil I.1 is replaced by the phenyluracil I.27.

Preference is also given to the compositions 28.1-28.43 which differ from the corresponding compositions 1.1-1.43 only in that the phenyluracil I.1 is replaced by the phenyluracil I.28.

Preference is also given to the compositions 29.1-29.43 which differ from the corresponding compositions 1.1-1.43 only in that the phenyluracil I.1 is replaced by the phenyluracil I.29.

Preference is also given to the compositions 30.1-30.43 which differ from the corresponding compositions 1.1-1.43 only in that the phenyluracil I.1 is replaced by the phenyluracil I.30.

Preference is also given to the compositions 31.1-31.43 which differ from the corresponding compositions 1.1-1.43 only in that the phenyluracil I.1 is replaced by the phenyluracil I.31.

Preference is also given to the compositions 32.1-32.43 which differ from the corresponding compositions 1.1-1.43 only in that the phenyluracil I.1 is replaced by the phenyluracil I.32.

Preference is also given to the compositions 33.1-33.43 which differ from the corresponding compositions 1.1-1.43 only in that the phenyluracil I.1 is replaced by the phenyluracil I.33.

Preference is also given to the compositions 34.1-34.43 which differ from the corresponding compositions 1.1-1.43 only in that the phenyluracil I.1 is replaced by the phenyluracil I.34.

Preference is also given to the compositions 35.1-35.43 which differ from the corresponding compositions 1.1-1.43 only in that the phenyluracil I.1 is replaced by the phenyluracil I.35.

Preference is also given to the compositions 36.1-36.43 which differ from the corresponding compositions 1.1-1.43 only in that the phenyluracil I.1 is replaced by the phenyluracil I.36.

Preference is also given to the compositions 37.1-37.43 which differ from the corresponding compositions 1.1-1.43 only in that the phenyluracil I.1 is replaced by the phenyluracil I.37.

Preference is also given to the compositions 38.1-38.43 which differ from the corresponding compositions 1.1-1.43 only in that the phenyluracil I.1 is replaced by the phenyluracil I.38.

Preference is also given to the compositions 39.1-39.43 which differ from the corresponding compositions 1.1-1.43 only in that the phenyluracil I.1 is replaced by the phenyluracil I.39.

Preference is also given to the compositions 40.1-40.43 which differ from the corresponding compositions 1.1-1.43 only in that the phenyluracil 1.1 is replaced by the phenyluracil I.40.

Preference is also given to the compositions 41.1-41.43 which differ from the corresponding compositions 1.1-1.43 only in that the phenyluracil I.1 is replaced by the phenyluracil I.41.

Preference is also given to the compositions 42.1-42.43 which differ from the corresponding compositions 1.1-1.43 only in that the phenyluracil I.1 is replaced by the phenyluracil I.42.

Preference is also given to the compositions 43.1-43.43 which differ from the corresponding compositions 1.1-1.43 only in that the phenyluracil I.1 is replaced by the phenyluracil I.43.

Preference is also given to the compositions 44.1-44.43 which differ from the corresponding compositions 1.1-1.43 only in that the phenyluracil I.1 is replaced by the phenyluracil I.44.

Preference is also given to the compositions 45.1-45.43 which differ from the corresponding compositions 1.1-1.43 only in that the phenyluracil I.1 is replaced by the phenyluracil I.45.

Preference is also given to the compositions 46.1-46.43 which differ from the corresponding compositions 1.1-1.43 only in that the phenyluracil I.1 is replaced by the phenyluracil I.46.

Preference is also given to the compositions 47.1-47.43 which differ from the corresponding compositions 1.1-1.43 only in that the phenyluracil I.1 is replaced by the phenyluracil I.47.

Preference is also given to the compositions 48.1-48.43 which differ from the corresponding compositions 1.1-1.43 only in that the phenyluracil I.1 is replaced by the phenyluracil I.48.

Preference is also given to the compositions 49.1-49.43 which differ from the corresponding compositions 1.1-1.43 only in that the phenyluracil I.1 is replaced by the phenyluracil I.49.

Preference is also given to the compositions 50.1-50.43 which differ from the corresponding compositions 1.1-1.43 only in that the phenyluracil I.1 is replaced by the phenyluracil I.50.

Preference is also given to the compositions 51.1-51.43 which differ from the corresponding compositions 1.1-1.43 only in that the phenyluracil I.1 is replaced by the phenyluracil I.51.

Preference is also given to the compositions 52.1-52.43 which differ from the corresponding compositions 1.1-1.43 only in that the phenyluracil I.1 is replaced by the phenyluracil I.52.

Preference is also given to the compositions 53.1-53.43 which differ from the corresponding compositions 1.1-1.43 only in that the phenyluracil I.1 is replaced by the phenyluracil I.53.

Preference is also given to the compositions 54.1-54.43 which differ from the corresponding compositions 1.1-1.43 only in that the phenyluracil I.1 is replaced by the phenyluracil I.54.

Preference is also given to the compositions 55.1-55.43 which differ from the corresponding compositions 1.1-1.43 only in that the phenyluracil I.1 is replaced by the phenyluracil I.55.

Preference is also given to the compositions 56.1-56.43 which differ from the corresponding compositions 1.1-1.43 only in that the phenyluracil I.1 is replaced by the phenyluracil I.56.

Preference is also given to the compositions 57.1-57.43 which differ from the corresponding compositions 1.1-1.43 only in that the phenyluracil 1.1 is replaced by the phenyluracil I.57.

Preference is also given to the compositions 58.1-58.43 which differ from the corresponding compositions 1.1-1.43 only in that the phenyluracil I.1 is replaced by the phenyluracil I.58.

Preference is also given to the compositions 59.1-59.43 which differ from the corresponding compositions 1.1-1.43 only in that the phenyluracil I.1 is replaced by the phenyluracil I.59.

Preference is also given to the compositions 60.1-60.43 which differ from the corresponding compositions 1.1-1.43 only in that the phenyluracil I.1 is replaced by the phenyluracil I.60.

Preference is also given to the compositions 61.1-61.43 which differ from the corresponding compositions 1.1-1.43 only in that the phenyluracil I.1 is replaced by the phenyluracil I.61.

Preference is also given to the compositions 62.1-62.43 which differ from the corresponding compositions 1.1-1.43 only in that the phenyluracil I.1 is replaced by the phenyluracil I.62.

Preference is also given to the compositions 63.1-63.43 which differ from the corresponding compositions 1.1-1.43 only in that the phenyluracil I.1 is replaced by the phenyluracil I.63.

Preference is also given to the compositions 64.1-64.43 which differ from the corresponding compositions 1.1-1.43 only in that the phenyluracil I.1 is replaced by the phenyluracil I.64.

Preference is also given to the compositions 65.1-65.43 which differ from the corresponding compositions 1.1-1.43 only in that the phenyluracil I.1 is replaced by the phenyluracil I.65.

Preference is also given to the compositions 66.1-66.43 which differ from the corresponding compositions 1.1-1.43 only in that the phenyluracil I.1 is replaced by the phenyluracil I.66.

Preference is also given to the compositions 67.1-67.43 which differ from the corresponding compositions 1.1-1.43 only in that the phenyluracil I.1 is replaced by the phenyluracil I.67.

Preference is also given to the compositions 68.1-68.43 which differ from the corresponding compositions 1.1-1.43 only in that the phenyluracil I.1 is replaced by the phenyluracil I.68.

Preference is also given to the compositions 69.1-69.43 which differ from the corresponding compositions 1.1-1.43 only in that the phenyluracil I.1 is replaced by the phenyluracil I.69.

Preference is also given to the compositions 70.1-70.43 which differ from the corresponding compositions 1.1-1.43 only in that the phenyluracil I.1 is replaced by the phenyluracil I.70.

Preference is also given to the compositions 71.1-71.43 which differ from the corresponding compositions 1.1-1.43 only in that the phenyluracil I.1 is replaced by the phenyluracil I.71.

Preference is also given to the compositions 72.1-72.43 which differ from the corresponding compositions 1.1-1.43 only in that the phenyluracil I.1 is replaced by the phenyluracil I.72.

Preference is also given to the compositions 73.1-73.43 which differ from the corresponding compositions 1.1-1.43 only in that the phenyluracil I.1 is replaced by the phenyluracil I.73.

Preference is also given to the compositions 74.1-74.43 which differ from the corresponding compositions 1.1-1.43 only in that the phenyluracil I.1 is replaced by the phenyluracil I.74.

The weight ratios of the individual components in the compositions 2.1 to 74.43 are within the limits stated above, in the case of binary mixtures of phenyluracil I.1 and herbicide B for example 1:1, 1:2 or 1:5, in the case of binary mixtures of phenyluracil I.1 and safener C for example 1:1, 1:2 or 1:5 and in the case of ternary mixtures of phenyluracil I.1, herbicide B and safener C for example 1:1:1, 2:1:1, 1:2:1, 1:5:1 or 1:5:2.

In the ready-to-use preparations, i.e. in the compositions according to the invention in the form of crop protection products, the components I and B and optionally C, in suspended, emulsified or dissolved form, can be present formulated jointly or separately. The use forms depend entirely on the intended use.

The compositions according to the invention can be applied, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, broadcasting or watering. The use forms depend on the intended use; in any case, they should ensure the finest possible distribution of the active compounds.

Depending on the form in which the ready-to-use preparations are present in the compositions according to the invention, they comprise one or more liquid or solid carriers, if appropriate surfactants and if appropriate further auxiliaries which are customary for formulating crop protection products. The person skilled in the art is sufficiently familiar with the recipes for such formulations.

The ready-to-use preparations comprise the components I and B and optionally C and auxiliaries which are customary for formulating crop protection products, which auxiliaries may also comprise a liquid carrier.

Suitable inert additives with carrier function are essentially: mineral oil fractions of medium to high boiling point, such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water.

Aqueous use forms can be prepared from emulsion concentrates, suspensions, pastes, wettable powders or water-dispersible granules by adding water. To prepare emulsions, pastes or oil dispersions, the active compounds I, B or C, as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Suitable surfactants are the alkali metal salts, alkaline earth metal salts and ammonium salts of aromatic sulfonic acids, e.g. ligno-, phenol-, naphthalene- and dibutylnaphthalenesulfonic acid, and of fatty acids, of alkyl- and alkylarylsulfonates, of alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene alkyl ether or polyoxypropylene alkyl ether, lauryl alcohol polyglycol ether acetate, sorbitol esters, lignosulfite waste liquors or methylcellulose.

Powders, materials for spreading and dusts can be prepared by mixing or concomitant grinding of the active substances with a solid carrier.

Granules, e.g. coated granules, impregnated granules and homogeneous granules, can be prepared by binding the active ingredients to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

The concentrations of the active compounds in the ready-to-use preparations can be varied within wide ranges. In general, the formulations comprise from 0.001 to 98% by weight, preferably 0.01 to 95% by weight, of active ingredients. The active ingredients are employed in a purity of from 90% to 100%, preferably 95% to 100% (according to NMR spectrum).

The compounds according to the invention can, for example, be formulated as follows:

I 20 parts by weight of the active compound or active compound mixture in question are dissolved in a mixture composed of 80 parts by weight of alkylated benzene, 10 parts by weight of the adduct of 8 to 10 mol of ethylene oxide to 1 mol of oleic acid N-monoethanolamide, 5 parts by weight of calcium dodecylbenzenesulfonate and 5 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.

II 20 parts by weight of the active compound or active compound mixture in question are dissolved in a mixture composed of 40 parts by weight of cyclohexanone, 30 parts by weight of isobutanol, 20 parts by weight of the adduct of 7 mol of ethylene oxide to 1 mol of isooctylphenol and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.

III 20 parts by weight of the active compound or active compound mixture in question are dissolved in a mixture composed of 25 parts by weight of cyclohexanone, 65 parts by weight of a mineral oil fraction of boiling point 210 to 280° C. and 10 parts by weight of the adduct of 40 mol of ethylene oxide to 1 mol of castor oil. Pouring the solution into 100 000 parts by weight of water and finely distributing it therein gives an aqueous dispersion which comprises 0.02% by weight of the active ingredient.

IV 20 parts by weight of the active compound or active compound mixture in question are mixed thoroughly with 3 parts by weight of sodium diisobutylnaphthalenesulfonate, 17 parts by weight of the sodium salt of a lignosulfonic acid from a sulfite waste liquor and 60 parts by weight of pulverulent silica gel, and the mixture is ground in a hammer mill. Finely distributing the mixture in 20 000 parts by weight of water gives a spray mixture which comprises 0.1% by weight of the active ingredient.

V 3 parts by weight of the active compound or active compound mixture in question are mixed with 97 parts by weight of finely divided kaolin. This gives a dust which comprises 3% by weight of the active ingredient.

VI 20 parts by weight of the active compound or active compound mixture in question are mixed intimately with 2 parts by weight of calcium dodecylbenzenesulfonate, 8 parts by weight of fatty alcohol polyglycol ether, 2 parts by weight of the sodium salt of a phenol-urea-formaldehyde condensate and 68 parts by weight of a paraffinic mineral oil. This gives a stable oily dispersion.

VII 1 part by weight of the active compound or active compound mixture in question is dissolved in a mixture composed of 70 parts by weight of cyclohexanone, 20 parts by weight of ethoxylated isooctylphenol and 10 parts by weight of ethoxylated castor oil. This gives a stable emulsion concentrate.

VIII 1 part by weight of the active compound or active compound mixture in question is dissolved in a mixture composed of 80 parts by weight of cyclohexanone and 20 parts by weight of Wettol® EM 31 (nonionic emulsifier based on ethoxylated castor oil). This gives a stable emulsion concentrate.

The components I and B and optionally C can be formulated jointly or separately.

The components I and B and optionally C can be applied jointly or separately, simultaneously or successively, before, during or after emergence of the plants.

If the active compounds I and B and optionally C are less well tolerated by certain crop plants, it is possible to use application methods in which the herbicidal compositions are sprayed with the aid of sprayers in such a way that the leaves of the sensitive crop plants are as far as possible unaffected, whereas the active compounds reach the leaves of the undesirable plants growing underneath or the uncovered soil surface (post-directed, lay-by).

The required application rate of the composition of the pure active compounds, i.e. of I and B and optionally C without formulation auxiliary, depends on the density of the undesired vegetation, on the development stage of the plants, on the climatic conditions of the location where the composition is used and on the application method. In general, the application rate of I and B and optionally C is from 0.001 to 3 kg/ha, preferably from 0.005 to 2 kg/ha and in particular from 0.01 to 1 kg/ha of active substance.

The required application rates of the 3-phenyluracils I are generally in the range from 0.1 g/ha to 1 kg/ha and preferably in the range from 1 g/ha to 500 g/ha or from 5 g/ha to 500 g/ha of active substance.

The compositions are applied to the plants mainly by foliar spraying. Application can be carried out by customary spraying techniques using, for example, water as carrier and spray liquor rates of from about 100 to 1 000 l/ha (for example from 300 to 400 l/ha). Application of the herbicidal compositions by the low-volume and the ultra-low-volume method is possible, as is their application in the form of microgranules.

The compositions according to the present invention are suitable for controlling common harmful plants in useful plants, in particular in crops such as wheat, barley, oats, corn, soybean, sorghum, rice, oilseed rape, cotton, potatoes, dry beans, ground-nuts or in perennial crops. In another embodiment of the invention, they are useful for controlling the whole vegetation, i. e. they act as a total weedkiller. Futhermore, in another emodiment of the present invention, the compositions are useful for controlling undesirable vegetation in forestry.

Moreover, it may be useful to apply the compositions according to the invention jointly as a mixture with other crop protection products, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates may also be added.

The compositions according to the invention can also be used in crop plants which are resistant to one or more herbicides owing to genetic engineering or breeding or which are resistant to attack by insects owing to genetic engineering or breeding. Suitable are for example crop plants preferably corn, wheat, barley, sunflower, rice, canola, soybeans which are resistant to herbicidal EPSP synthase inhibitors, such as, for example, glyphosate, to herbicidal glutamine synthase inhibitors, such as, for example, glufosinate, to herbicidal protoporphyrinogen-IX oxidase inhibitors, such as, for example, butafenacil, or to herbicidal ALS inhibitors, such as, for example, imazamethabenz, imazamox, imazapic, imazapyr, imazaquin, imazethapyr, or crop plants which, owing to introduction of the gene for Bt toxin by genetic modification, are resistant to attack by certain insects.

Surprisingly, the compositions according to the invention which comprise at least one phenyluracil of the formula I and at least one herbicide B have better herbicidal activity against harmful plants than would have been expected by the herbicidal activity of the individual compounds. In other words, the joint action of phenyluracil I and herbicide B results in an enhanced activity against harmful plants in the sense of a synergy effect (synergism). For this reason, the mixtures can, based on the individual components, be used at lower application rates to achieve a herbicidal effect comparable to the individual components.

Surprisingly, the compositions according to the invention which, in addition to the phenyluracil I and the herbicide B comprise an active compound from group C are better tolerated by useful plants than the respective mixture of 3-phenyluracil I+herbicide B without active compound of group C.

The 3-phenyluracils of the formula I can be prepared by the preparation processes disclosed by the earlier application WO 2001/83459. With respect to the preparation of individual compounds, reference is made to the examples of WO 2001/83459. Compounds which are not explicitly disclosed in this document can be prepared in an analogous manner.

### USE EXAMPLES

The effect of the herbicidal mixtures according to the invention of components I and B and, if appropriate, C on the growth of undesirable plants compared to the herbicidally active compounds alone was demonstrated by the following greenhouse experiments

For the post-emergence treatment, the test plants were first grown to a height of 3 to 20 cm, depending on the plant habit, and only then treated. Here, the herbicidal compositions were suspended or emulsified in water as distribution medium and sprayed using finely distributing nozzles.

The respective components I and B and/or C were formulated as 10% by weight strength emulsion concentrate and introduced to the spray liquor with the amount of solvent system used for applying the active compound. In the examples, the solvent used was water.

The test period extended over 21 days. During this time, the plants were tended, and their response to the treatments with active compound was evaluated.

The evaluation for the damage caused by the chemical compositions was carried out using a scale from 0 to 100%, compared to the untreated control plants. Here, 0 means no damage and 100 means complete destruction of the plants.

In the examples below, the value E which is to be expected if the activity of the individual compounds is just additive was calculated using the method of S. R. Colby (1967) “Calculating synergistic and antagonistic responses of herbicide combinations”, Weeds 15, p. 22 ff.
E=X+Y−(X·Y/100)
where

X=effect in percent using active compound I at an application rate a;

Y=effect in percent using active compound B at an application rate b;

E=expected effect (in %) of I+B at application rates a+b.

If the value calculated in this manner is higher than the value E calculated according to Colby, a synergistic effect is present.

The following active compounds were tested:

Phenyluracil I.1 from table 1 (example 54 from WO 2001/83459);

4-Hydroxy-3-{[2-methyl-6-(triflurmethyl)-3-pyridinyl]carbonyl}ci-cyclo[3.2.1]oct-3-en-2-one (herbicide B.1);

4-Hydroxy-3-{[2-methoxyethoxy)methyl-6-(trifluormethyl)-3-pyridinyl]carbonyl}bicyclo[3.2.1]oct-3-en-2-one (herbicide B.2).

The plants used in these greenhouse experiments belong to the following species:

| Scientific name | Common name |
|---|---|
| Alopecurus myosuroides | Blackgross |
| Amaranthus retroflexus | Common amaranth |
| Echinocloa crus-galli | Cockspur |

### Example 1

### Herbicidal Activity of Mixture 1.14 Applied by the Pre-Emergence Method

| | |
|---|---|
| | Herbicidal activity against |
| Application rate [g/ha] | Amaranthus retroflexus |

| I.1 | B.1 | found | calculated |
|---|---|---|---|
| 0.98 | — | 0 | — |
| — | 0.98 | 0 | — |
| 0.98 | 0.98 | 25 | 0 |
| 1.95 | — | 0 | — |
| — | 1.95 | 20 | — |
| 1.95 | 1.95 | 50 | 20 |

### Example 2

### Herbicidal Activity of Mixture 1.14 Applied by the Post-Emergence Method

| | |
|---|---|
| | Herbicidal activity against |
| Application rate [g/ha] | Echinocloa crus-galli |

| I.1 | B.1 | found | calculated |
|---|---|---|---|
| 0.98 | — | 0 | — |
| — | 0.98 | 30 | — |
| 0.98 | 0.98 | 70 | 30 |
| 1.95 | — | 0 | — |
| — | 1.95 | 60 | — |
| 1.95 | 1.95 | 80 | 60 |

### Example 3

### Herbicidal Activity of Mixture 1.19 Applied by the Post-Emergence Method

| | |
|---|---|
| | Herbicidal activity against |
| Application rate [g/ha] | Alopecurus myosuroides |

| I.1 | B.2 | found | calculated |
|---|---|---|---|
| 1.95 | — | 0 | — |
| — | 1.95 | 0 | — |
| 1.95 | 1.95 | 10 | 0 |
| 3.91 | — | 0 | — |
| — | 3.91 | 0 | — |
| 3.91 | 3.91 | 15 | 0 |

The data according to examples 1 to 3 prove unambigously the synergistic effect of the herbicidal mixtures according to the invention.

1. A herbicidal active composition comprising at least one 3-phenyluracil of the formula I 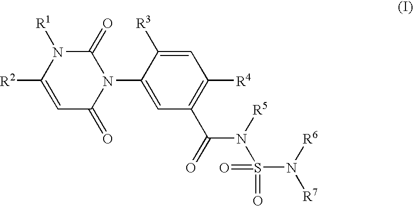
in which the variables R¹-R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the last 8 abovementioned substituents is unsubstituted or substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl and benzyl; or
R⁶, R⁷ together with the nitrogen atom to which they are attached form a 3-, 4-, 5-, 6- or 7-membered saturated or unsaturated nitrogen heterocycle which may be substituted by 1 to 6 methyl groups and which may contain 1 or 2 further heteroatoms selected from the group consisting of nitrogen, oxygen and sulfur as ring members,
or an agriculturally acceptable salts thereof; and
at least one further herbicide B, selected from the group consisting of aminopyralid and its agriculturally acceptable derivatives, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoromethyl)-3-pyridinyl]carbonyl}bicyclo[3.2.1]oct-3-en-2-one, 4-hydroxy-3-[4-(methylsulfonyl)-2-nitrobenzoyl]bicyclo[3.2.1]oct-3-en-2-one,
8-(2,6-diethyl-4-methylphenyl)-1,2,4,5-tetrahydro-9-hydroxy-7H-pyrazolo[1,2-d][1,4,5]oxadiazepin-7-one, pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden) and
[N-(5,7-dimethoxy[1,2,4]triazolo[1,5-a]pyrimidin-2-yl)-2- methoxy-4-(trifluoromethyl)-3-pyridinesulfonamide,
or an agriculturally acceptable salts thereof;
and optionally
at least one safener C, selected from the group consisting of benoxacor, cloquintocet, cyometrinil, dichlormid, dicyclonon, dietholate, fenchlorazole, fenclorim, flurazole, fuxofenim, flurilazole, isoxadifen, mefenpyr, mephenate, naphthalic anhydride, 2,2,5-trimethyl-3-(dichloracetyl-1,3-oxazolidine (R-29148), 4-(dichloroacetyl)-1-oxa-4-azaspiro[4.5]decane (AD-67, MON 4660) and oxabetrinil,
or an agriculturally acceptable salt thereof, or, provided the safener C has a carboxyl group, an agriculturally acceptable derivative thereof.

2. The herbicidal active composition as claimed in claim 1, in which the herbicide B is selected from the group consisting of aminopyralid and its agriculturally acceptable derivates, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoromethyl)-3-pyridinyl]carbonyl}bicyclo[3.2.1]oct-3-en-2-one, 4-hydroxy-3-[4-(methylsulfonyl)-2-nitrobenzoyl]bicyclo[3.2.1]-oct-3-en-2-one,
8-(2,6-diethyl-4-methylphenyl)-1,2,4,5-tetrahydro-9-hydroxy-7H-pyrazolo[1,2-d][1,4,5]oxadiazepin-7-one and
pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden),
or an agriculturally acceptable salt of said herbicide B.

3. The herbicidal active composition as claimed in claim 1, in which the herbicide B is selected from the group consisting of aminopyralid and its agriculturally acceptable derivatives,
4-hydroxy-3-{[2-(2-methoxyethoxy)methyl-6-(trifluormethyl)-3-pyridinyl]carbonyl}bicyclo[3.2.1]oct-3-en-2-one, pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden) and
[N-(5,7-dimethoxy[1,2,4]triazolo[1,5-a]pyrimidin-2-yl)-2- methoxy-4-(trifluoromethyl)-3-pyridinesulfonamide,
or an agricultural acceptable salt of said herbicide B.

4. The herbicidal active composition as claimed in claim 1 in which the variables R¹ to R⁷ in formula I have the following meaning:
R¹ is methyl or NH₂;
R² is trifluoromethyl;
R³ is hydrogen, fluorine or chlorine;
R⁴ is halogen or cyano;
R⁵ is hydrogen;
R⁶, R⁷ independently of one another are hydrogen, C₁-C₆-alkyl, C₃-C₆-alkenyl, C₃-C₆-alkynyl, C₃-C₇-cycloalkyl, C₃-C₇-cycloalkenyl, phenyl or benzyl, or
R⁶, R⁷ together with the nitrogen atom to which they are attached form a pyrrolidine, piperidine, morpholine, N-methylpiperazine or perhydroazepine ring.

5. The herbicidal active composition as claimed in claim 1, in which R⁶, R⁷ in formula I are identical or different C₁-C₆-alkyl radicals.

6. The herbicidal active composition as claimed in claim 1, in which the compound C is selected from the group consisting of benoxacor, cloquintocet, dichlormid, fenchlorazole, fenclorim, fluxofenim, furilazole, isoxadifen, mefenpyr, 2,2,5-trimethyl-3-(dichloracetyl)-1,3-oxazolidine,
4-(dichloroacetyl)-1-oxa-4-azaspiro[4.5]decane and oxabetrinil
and/or an agriculturally acceptable salt of said compound C and/or, in the case of a compound C having a COOH group, an agriculturally acceptable derivative of said compound C.

7. The herbicidal active composition as claimed in claim 1 in which the herbicide B is 4-hydroxy-3-{[2-(2-methoxyethoxy)methyl-6-(trifluoromethyl)-3-pyridinyl)carbonyl}-bicyclo[3.2.1]oct-3-en-2-one or an agriculturally acceptable salt thereof.

8. The herbicidal active composition as claimed in claim 1 in which the herbicid B is pivalic acid [8-(2,6-diethyl-4-methylphenyl)1,2,4,5-tetrahydro-7-oxo-7H-pyrazolo[1,2-d][1,4,5]oxadiazepin-9-yl]ester (pinoxaden), or an agriculturally acceptable salt thereof.

9. The herbicidal active composition as claimed in claim 1 in which the herbicide B is [N-(5,7-dimethoxy[1,2,4]triazolo[1,5-a]pyrimidin-2-yl)-2-methoxy-4-(trifluoromethyl)-3-pyridinesulfonamide or an agriculturally acceptable salt thereof.

10. A herbicidal agent, comprising the herbicidal active composition as claimed in claim 1, at least one inert liquid and/or solid carrier, if desired at least one surfactant and, if appropriate at least one further auxiliary.

11. A method for controlling undesirable vegetation, which comprisis allowing a herbicidally effective amount of a composition as claimed in claim 1 to act on plants, their habitat or on seed.

12. The method as claimed in claim 11, which comprises applying said composition during and/or after emergence of the undesirable vegetation, simultaneously or in succession.

13-15. (canceled)

16. The method of claim 11, wherein the composition controls undesirable vegetation in cereal or corn crops.

17. The method of claim 11, wherein the composition controls undesirable vegetation in forestry.

18. The method of claim 11, wherein the composition controls undesirable vegetation in crop plants, wherein the crop plants are resistant to at least one herbicide owing to genetic engineering and/or breeding.

19. A herbicidal kit comprising a container containing at least one 3-phenyluracil of the formula I 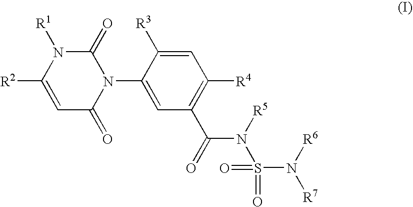
in which the variables R¹-R⁷ are as defined below:
R¹ is methyl or NH₂;
R² is C₁-C₂-haloalkyl;
R³ is hydrogen or halogen;
R⁴ is halogen or cyano;
R⁵ is hydrogen, cyano, C₁-C₆-alkyl, C₁-C₆-alkoxy, C₁-C₄-alkoxy-C₁-C₄-alkyl, C₃-C₇-cycloalkyl, C₃-C₆-alkenyl, C₃-C₆-alkynyl or benzyl which is unsubstituted or substituted by halogen or C₁-C₆-alkyl;
R⁶, R⁷ independently of one another are hydrogen, C₁-C₆-alkyl, C₁-C₆-alkoxy, C₃-C₆-alkenyl, C₃-C₆-alkynyl, C₃-C₇-cycloalkyl, C₃-C₇-cycloalkenyl, phenyl or benzyl, where each of the—8 above mentioned substituents is unsubstituted or substituted by 1 to 6 halogen atoms and/or by one, two or three groups selected from: OH, NH₂, CN, CONH₂, C₁-C₄-alkoxy, C₁-C₄-haloalkoxy, C₁-C₄-alkylthio, C₁-C₄-haloalkylthio, C₁-C₄-alkylsulfonyl, C₁-C₄-haloalkylsulfonyl, C₁-C₄-alkylamino, di(C₁-C₄-alkyl)amino, formyl, C₁-C₄-alkylcarbonyl, C₁-C₄-alkoxycarbonyl, C₁-C₄-alkylaminocarbonyl, di(C₁-C₄-alkyl)aminocarbonyl, C₃-C₇-cycloalkyl, phenyl and benzyl; or
R⁶, R⁷ together with the nitrogen atom to which they are attached form a 3-, 4-, 5-, 6- or 7-membered saturated or unsaturated nitrogen heterocycle which may be substituted by 1 to 6 methyl groups and which may contain 1 or 2 further heteroatoms selected from the group consisting of nitrogen, oxygen and sulfur as ring members,
including an agriculturally acceptable salt thereof;
and a separate container containing at least one further herbicide B at least one further herbicide B, selected from the group consisting of aminopyralid and its agriculturally acceptable derivatives, 4-hydroxy-3-{[2-methyl-6-(trifluoromethyl)-3-pyridinyl]carbonyl}bicyclo[3.2.1]oct-3-en-2-one, 4-hydroxy-3-{[2-(2-methoxyethoxy)methyl-6-(trifluoromethyl)-3-pyridinyl]carbonyl}bicyclo[3.2.1]oct-3-en-2-one, 4-hydroxy-3-[4-(methylsulfonyl)-2-nitrobenzoyl]bicyclo[3.2.1]oct-3-en-2-one,
8-(2,6-diethyl-4-methylphenyl)-1,2,4,5-tetrahydro-9-hydroxy-7H-pyrazolo[1,2-d][1,4,5]oxadiazepin-7-one, pivalic acid [8-(2,6-diethyl-4-methylphenyl)-1,2,4,5-tetrahydro-7-oxo-7H-pyrazolo[1,2-d][1,4,5]oxadiazepin-9-yl]ester (pinoxaden) and
[N-(5,7-dimethoxy[1,2,4]triazolo[1,5-a]pyrimidin-2-yl)-2-methoxy-4-(trifluoromethyl)-3-pyridinesulfonamide,
including an agriculturally acceptable salt of said herbicide B.

20. The kit of claim 19, further comprising at least one safener C, selected from the group consisting of benoxacor, cloquintocet, cyometrinil, dichlormid, dicyclonon, dietholate, fenchlorazole, fenclorim, flurazole, fuxofenim, flurilazole, isoxadifen, mefenpyr, mephenate, naphthalic anhydride, 2,2,5-trimethyl-3-(dichloracetyl-1,3-oxazolidine (R-29148), 4-(dichloroacetyl)-1-oxa-4-azaspiro[4.5]decane (AD-67, MON 4660) and oxabetrinil, or an agriculturally acceptable salt of said safener C, or, provided safener C has a carboxyl group, an agriculturally acceptable derivative of said safener C.
